(19) United States
(12) Patent Application Publication
(10) Pub. No.: US 2025/0251998 A1
(43) Pub. Date: Aug. 7, 2025

(54) METHOD FOR PUSHING AN EVENT, MEDIUM AND ELECTRONIC DEVICE

(71) Applicant: Beijing Youzhuju Network Technology Co., Ltd., Beijing (CN)

(72) Inventors: Haiyang DING, Beijing (CN); Qingyu JIANG, Beijing (CN); Zhenfang WANG, Beijing (CN)

(21) Appl. No.: 19/044,624

(22) Filed: Feb. 4, 2025

(30) Foreign Application Priority Data
Feb. 5, 2024 (CN) 202410168880.7

(51) Int. Cl. G06F 9/54; G06Q 30/0241

(52) U.S. Cl. CPC G06F 9/542; G06Q 30/0241

(57) ABSTRACT

The present disclosure relates to a method for pushing an event, a medium and an electronic device. The method includes: obtaining an event message, wherein the event message is an event representing that change occurs for data of an advertisement corresponding to the event message; writing an object identifier of the event message for which a first time stamp is within a preset aggregation time window into a corresponding data set according to the preset aggregation time window, wherein the object identifier is used for identifying the advertisement; and reading the object identifier in the data set, and pushing the object identifier to an advertiser terminal corresponding to the object identifier, so that the advertiser terminal obtains advertisement data corresponding to the object identifier according to the object identifier.

### CROSS-REFERENCE TO RELATED APPLICATION

The present application claims the priority and benefits of Chinese Patent Application No. 202410168880.7, filed Feb. 5, 2024, which is incorporated herein by reference in its entirety as part of the present application.

### TECHNICAL FIELD

The embodiment of present disclosure relates to a method for pushing an event, an apparatus, a medium and an electronic device.

### BACKGROUND

After an advertiser publishes an advertisement, the advertiser usually needs to know a delivery effect of the advertisement, which requires a platform to push relevant data to the advertiser. For example, the platform actively pushes changed advertisement data to the advertiser through address callback. However, the real-time pushing method will cause a huge request pressure on a reception service of the advertiser, and different advertisers also have different requirements for data invalidity, and the current pushing method cannot meet such requirements.

### SUMMARY

The Summary is provided to introduce concepts in a simplified form that are described in detail in the following Detailed Description section. The Summary section is not intended to identify key features or essential features of the claimed technical solution, nor is it intended to be used to limit the scope of the claimed technical solution.

The present disclosure provides a method for pushing an event, including:
obtaining an event message, where the event message is an event representing that change occurs for data of an advertisement corresponding to the event message;
writing an object identifier of the event message for which first time stamp is within a preset aggregation time window into a corresponding data set according to the preset aggregation time window, where the object identifier is used for identifying the advertisement; and
reading the object identifier in the data set, and pushing the object identifier to an advertiser terminal corresponding to the object identifier, so that the advertiser terminal obtains advertisement data corresponding to the object identifier according to the object identifier.

The present disclosure provides an apparatus for pushing an event, including: an obtaining module, a writing module and a pushing module.

The obtaining module is configured to obtain an event message, where the event message is an event representing that change occurs for data of an advertisement corresponding to the event message.

The writing module is configured to write an object identifier of the event message for which first time stamp is within a preset aggregation time window into a corresponding data set according to the preset aggregation time window, where the object identifier is used for identifying the advertisement.

The pushing module is configured to read the object identifier in the data set, and push the object identifier to an advertiser terminal corresponding to the object identifier, so that the advertiser terminal obtains advertisement data corresponding to the object identifier according to the object identifier.

The present disclosure provides a computer-readable medium, having a computer program stored thereon, and when the program is executed by a processing apparatus, implements the method described above.

The present disclosure provides an electronic device, including:
a storage apparatus, having a computer program stored thereon; and
a processing apparatus, configured to execute the computer program in the storage apparatus, to implement the method described above.

Other features and advantages of the present disclosure will be described in detail in the following detailed description section.

### BRIEF DESCRIPTION OF DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale. In the drawings:

FIG. 1 is a flowchart of a method for pushing an event according to some embodiments.

FIG. 2 is a schematic diagram of a data set according to an exemplary embodiment.

FIG. 3 is a schematic diagram of pushing of an object identifier according to an exemplary embodiment.

FIG. 4 is a schematic diagram of a mapping table according to an exemplary embodiment.

FIG. 5 is a schematic diagram of module connection in an apparatus for pushing an event according to an exemplary embodiment.

FIG. 6 is a schematic structural diagram of an electronic device according to an exemplary embodiment.

### DETAILED DESCRIPTION

Embodiments of the present disclosure will be described in more detail below with reference to the drawings. Although some embodiments of the present disclosure are shown in the drawings, it should be understood that the present disclosure can be implemented in various forms, and should not be construed as being limited to the embodiments set forth herein, but rather these embodiments are provided for a more thorough and complete understanding of the present disclosure. It should be understood that the drawings and the embodiments of the present disclosure are only for exemplary purposes, and are not intended to limit the scope of the present disclosure.

It should be understood that various steps described in method implementations of the present disclosure can be performed in different orders and/or in parallel. Furthermore, the method implementations can include additional steps and/or omit performing the illustrated steps. The scope of the present disclosure is not limited in this respect.

The term “include” and its variants as used herein are open-ended inclusions, that is, “include but not limited to”. The term “based on” is “at least partially based on”. The term “one embodiment” means “at least one embodiment”; the term “another embodiment” means “at least one other embodiment”; the term “some embodiments” means “at least some embodiments”. Relevant definitions of other terms will be given in the description below.

It should be noted that the concepts of “first”, “second”, etc. mentioned in the present disclosure are only used to distinguish between different apparatus, modules or units, and are not used to limit the order of the functions performed by these apparatus, modules or units or interdependence therebetween.

It should be noted that the modifiers “one” and “a plurality of” mentioned in the present disclosure are illustrative and not restrictive, and those skilled in the art should understand that unless the context clearly indicates otherwise, they should be understood as “one or more”.

Names of messages or information exchanged between apparatuses in the implementations of the present disclosure are only for illustrative purposes, and are not intended to limit the scope of these messages or information.

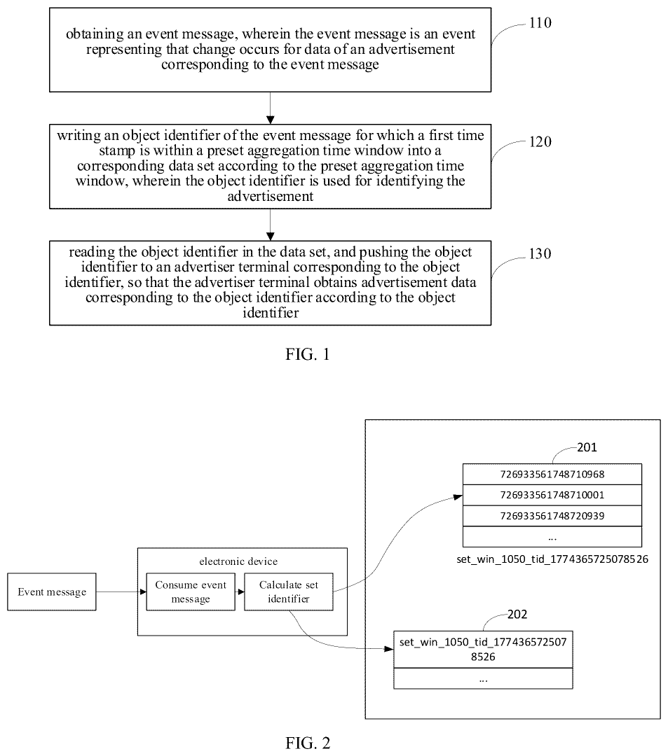

FIG. 1 is a flowchart of a method for pushing an event according to some embodiments. As shown in FIG. 1, the embodiments of the present disclosure provide a method for pushing an event, which can be executed by an electronic device, and specifically, can be executed by an apparatus for pushing an event, where the apparatus can be implemented in software and/or hardware, and is configured in the electronic device. It should be understood that the electronic device can be a server or a terminal device. As shown in FIG. 1, the method can include the following steps.

In step 110, an event message is obtained, where the event message is an event representing that change occurs for data of an advertisement corresponding to the event message.

The event message may be generated by a server responsible for monitoring data of an advertisement, and the server sends the event message to the server after detecting that the data of the advertisement has changed, so as to notify the server that the data of the advertisement has changed through the event message. The data of the advertisement has changed may refer to a change in assets of an advertiser corresponding to the advertisement, or a change in indicators such as the number of clicks or the exposure rate of the advertisement.

In step 120, an object identifier of the event message for which first time stamp is within a preset aggregation time window is written into a corresponding data set according to the preset aggregation time window, where the object identifier is used for identifying the advertisement corresponding to the event message.

The aggregation time window is a time range, such as a time window of one minute, five minutes, and ten minutes, etc. It should be understood that a user can customize the time span of each aggregation time window. For example, the starting time of an aggregation time window may be an ending time of the previous aggregation time window.

The first time stamp may be an original time stamp of the event message, for example, the first time stamp may be represented by 1691471027. The event message carries an object identifier used for identifying an advertisement corresponding to the event message. For example, for an advertisement, the object identifier of the advertisement may be an advertisement ID (Identity document, unique code) of the advertisement.

Exemplarily, the object identifier may represent the corresponding advertisement through a globally unique code of 72169335617468710968.

The server obtains the event message for which first time stamp is within the aggregation time window according to the aggregation time window, and writes the obtained event message into the corresponding data set. For example, assuming that the aggregation time window is [16:25:21, 16:26:21], the object identifier carried in the event message obtained in this time period from 16:25:21 to 16:26:21 is written into the data set.

Exemplarily, the data set may be a set stored in a database. For example, the database may be a Redis database (an open-source high-performance key-value pair storage database).

In step 130, the object identifier in the data set is read, and the object identifier is pushed to an advertiser terminal corresponding to the object identifier, so that the advertiser terminal obtains advertisement data corresponding to the object identifier according to the object identifier.

The advertiser terminal may be a terminal device corresponding to an advertiser who publishes the above advertisement. When the server obtains the event message, it means that there is a change in the data of the advertisement published by the advertiser. At this time, the advertiser who has a change in data needs to be notified of the change in the advertisement published by the advertiser, and the corresponding object identifier is pushed to the corresponding advertiser terminal.

The server may read the object identifier in the data set according to a certain time period, and send the read object identifier to the advertiser terminal corresponding to the object identifier. The advertiser terminal receives the object identifier, and pulls advertisement data corresponding to the object identifier from the server according to the object identifier.

For example, when the data set includes object identifiers of 72169335617468710968, 72169335617468710001, and 72169335617468750939, the server sends the corresponding object identifiers to the advertiser terminals corresponding to the respective object identifiers.

It should be understood that the advertisement data corresponding to the object identifier can be generated according to data carried in the corresponding event message. For example, the advertisement data can be an advertisement report generated based on the event message corresponding to the object identifier, and the advertisement report records data such as the exposure rate, the click rate, and asset information.

Therefore, by obtaining an event message, writing an object identifier of the event message for which first time stamp is within a preset aggregation time window into a corresponding data set according to the preset aggregation time window, reading the object identifier in the data set, and pushing the object identifier to an advertiser terminal corresponding to the object identifier, the object identifier corresponding to the advertisement can be pushed to the advertiser terminal at a set period, thereby avoiding request pressure caused by real-time pushing to the advertiser terminal. In addition, by sending the object identifier, the amount of data in an event notification can be reduced.

In some implementations that can be implemented, the data set includes a first set and a second set, the first set is used for storing an object identifier corresponding to an advertisement published by a same advertiser, and the second set is used for storing an aggregation identifier corresponding to the first set.

For each advertiser, a first set for storing object identifiers of advertisements published by the advertiser can be maintained in the database. It should be noted that, in a server, when the server needs to monitor whether data of advertisements published by multiple advertisers has changed, multiple first sets can be maintained in the database, and each first set is used for storing object identifiers corresponding to one advertiser.

The second set is a set for storing an aggregation identifier corresponding to the first set that is maintained in the database. The aggregation identifier is used for identifying the first set corresponding to the aggregation identifier, so as to distinguish between first sets corresponding to different advertisers. Exemplarily, the aggregation identifier may be an aggregation key. For example, the aggregation identifier may be represented by set_win_1050_tid_1774365725078526, and different first sets have different corresponding aggregation identifiers.

For each advertiser managed by the server, the server may use the aggregation identifier as a name of the first set corresponding to the advertiser. When a new event message arrives, the aggregation identifier is used as a name of the first set in Redis, and the object identifier in the event message is used as an element in the first set.

When there is a first set with updated data among the multiple first sets, the aggregation identifier corresponding to the first set with updated data can be written into the second set.

It is worth noting that, through the first set, advertisements belonging to the same advertiser can be grouped into one set for management, and in the process of pushing the object identifier, there is no need to re-identify an advertiser terminal to which each object identifier in the first set belongs.

In addition, it should be noted that, in each aggregation time window, there can be one or more first sets belonging to the aggregation time window to store object identifiers of event messages received in the aggregation time window.

Accordingly, in step 120, the object identifier of the event message for which first time stamp is within the aggregation time window can be written into the corresponding first set according to the preset aggregation time window, and the aggregation identifier corresponding to the first set can be written into the second set in response to an end of the aggregation time window.

For each obtained event message, when the first time stamp of the event message is within the preset aggregation time window, the object identifier of the event message is written into the corresponding first set. The corresponding first set refers to a first set to which the advertiser corresponding to the event message belongs.

When the aggregation time window ends, it means that the event message for which first time stamp is within the preset aggregation time window has been processed. At this time, no new object identifier will be written into the first set, and the aggregation identifier corresponding to the first set may be written into the second set.

It should be understood that writing the aggregation identifier corresponding to the first set into the second set actually means that the statistics of the event messages in one aggregation time window has been completed.

FIG. 2 is a schematic diagram of a data set according to an exemplary embodiment. As shown in FIG. 2, the server receives an event message, a server consume event message, calculates an aggregation identifier of the event message according to the object identifier carried in the event message, and writes the object identifier carried in the event message into a first set 201 corresponding to the aggregation identifier. Then, after one aggregation time window ends, an aggregation identifier of the first set 201 with updated data is written into a second set 202.

Therefore, by grouping advertisements belonging to the same advertiser into the corresponding first set, in the process of pushing the object identifier, there is no need to re-identify an advertiser terminal to which each object identifier in the first set belongs.

In some implementations that can be implemented, the object identifier of the event message for which first time stamp is within the aggregation time window may be written into the corresponding first set according to the preset aggregation time window and in combination with a preset deduplication rule.

The preset deduplication rule may be a uniqueness rule. That is, in one aggregation time window, even if there are multiple event messages with the same object identifier, the object identifier written into the first set is unique.

For example, when the object identifier of 72169335617468710968 already exists in the first set, and when there is a new event message with the object identifier of 72169335617468710968 in the aggregation time window, 72169335617468710968 will not be written into the first set again.

Therefore, by writing the object identifier of the event message for which first time stamp is within the aggregation time window into the corresponding first set through the preset deduplication rule, the amount of data pushed to the advertiser terminal can be reduced, thereby reducing the request pressure of the advertiser terminal.

In some implementations that may be implemented, in step 130, the aggregation identifier may be read from the second set according to a preset time period, the object identifier may be read from the first set corresponding to the aggregation identifier according to the aggregation identifier, and the object identifier may be pushed to the advertiser terminal corresponding to the read object identifier.

The preset time period may be a time period set by the server. For example, the preset time period may be 1 minute or 5 minutes. Of course, the preset time period may be a time period set by the advertiser. The advertiser may customize the preset time period according to its requirements for data timeliness.

The object identifiers aggregated in one aggregation time window are stored in the first set, and then the aggregation identifier corresponding to the first set generated in one aggregation time window is stored in the second set to indicate that there is a change in the advertisement data corresponding to the advertiser.

The server may generate a window close event according to a timestamp of the last time the object identifier was pushed, in combination with the preset time period. Then, the server executes the window close event, scans the aggregation identifier in the second set, and obtains the aggregation identifier for which window timestamp matches the window close event. Next, the server reads all object identifiers from the first set corresponding to the aggregation identifier based on the aggregation identifier being read, and pushes the object identifiers being read to the advertiser terminal matching the object identifier.

It should be understood that, after the read object identifier is pushed to the advertiser terminal matching the object identifier, the object identifier in the first set may be deleted.

In some embodiments, the read object identifier may be segmented according to a preset segmentation size to obtain multiple data segments, and for each of the data segments, the data segment is sent to a corresponding advertiser terminal through a request message.

The preset segmentation size may be set by the user, such as 50 bytes for a size of a data segment. After the server reads all object identifiers in the first set, all the object identifiers being read are split into multiple data segments according to the preset segmentation size. Then, for each data segment, an object identifier carried in the HTTP (Hypertext Transfer Protocol) request message can be callback to the advertiser terminal by sending an HTTP request message to the advertiser terminal.

It should be noted that, after a window close event is executed, the timestamp of the aggregation identifier that has been processed in the second set may be updated to the window timestamp corresponding to the window close event. When the object identifier is pushed next time, a new window close event can be determined according to the updated window timestamp, so as to prevent a push from being missed.

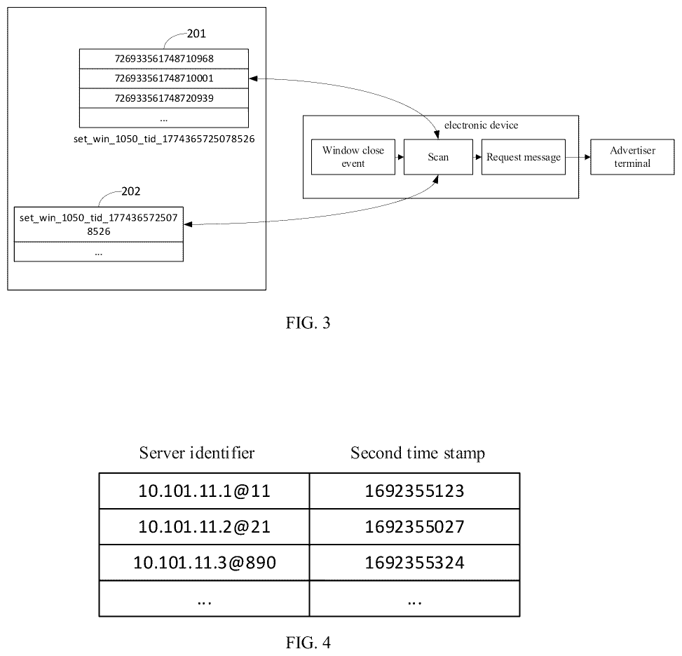

FIG. 3 is a schematic diagram of pushing of an object identifier according to an exemplary embodiment. As shown in FIG. 3, the server may read a timestamp of the last push from the database, and then generate a window close event based on a preset time period, and then execute the window close event, and start to scan the aggregation identifier in the second set 202. For each scanned aggregation identifier, the object identifier in the first set 201 corresponding to the aggregation identifier is read, and the read object identifier is sent to the advertiser terminal through a request message.

Therefore, through the above implementations, the object identifier after deduplication and aggregation may be callback to the advertiser terminal in batches according to the preset segmentation size, thereby ensuring that requests callback to the advertiser terminal may be evenly distributed over time, and avoiding a relatively large request pressure on the advertiser terminal.

In some implementations that may be implemented, a random offset corresponding to the event message is determined according to the object identifier carried in the event message, and a first time stamp corresponding to the event message is determined according to the random offset and an original time stamp of the event message.

The random offset is a random time interval added to the time stamp of the event message. The random offset may be added to the time stamp assigned to the event message when the event message enters the server.

Exemplarily, the random offset corresponding to the event message may be generated through a hash function in combination with the object identifier.

In some embodiments, the random offset may be added to the original time stamp of the event message to obtain the first time stamp.

It is worth noting that the first time stamp is a new time stamp of the event message after the original time stamp is adjusted by the random offset, and the object identifier is subsequently written based on the new time stamp.

Therefore, by introducing the random offset, the data can be evenly distributed among multiple aggregation time windows, thereby avoiding a traffic spike.

In some implementations that may be implemented, a mapping table is obtained, where the mapping table includes a server identifier corresponding to a server and a second time stamp corresponding to the server identifier which are periodically written into the mapping table by the server in a cluster. For each server identifier, a duration of the server identifier in the mapping table is determined according to the second time stamp corresponding to the server identifier, and a target server identifier is determined according to the duration, where the target server identifier is a server identifier with a duration greater than a preset duration threshold. Then, advertisement groups to be distributed are evenly distributed to a server corresponding to the target server identifier, so that the server obtains an event message corresponding to the advertisement groups, where the advertisement groups include advertisements published by a same advertiser.

Each server in the cluster has a globally unique server identifier to indicate the corresponding server through the server identifier. For example, the format of the server identifier may be IP (Internet Protocol) address @ process ID. The IP address is the IP address of the server, and the process ID is the ID corresponding to the process in which the server processes the event message. For example, the server identifier may be expressed as 10.10.111.12@1011, 10.10.111.12 is the IP address of the server, and 1011 is the process ID.

The mapping table may be stored in a database, which may be a Redis database. The server in the cluster periodically writes the server identifier corresponding to the server and the second time stamp corresponding to the server identifier into the mapping table. For example, the server may write the server identifier and the second time stamp into the mapping table at intervals of 1 minute.

The second time stamp may be the timestamp when the server identifier is written. FIG. 4 is a schematic diagram of a mapping table according to an exemplary embodiment. As shown in FIG. 4, the second timestamp of the server identifier of 10.101.11.1@11 is 1692355123.

Each server may read the mapping table in the database at set time intervals. The set time interval may be set according to user requirements, such as 1 minute, etc.

The duration of the server identifier in the mapping table refers to the duration of the timestamp of the same server identifier in the written mapping table. After reading the mapping table, the server calculates the duration corresponding to each server identifier, and determines the server identifier with a duration greater than a preset duration threshold as a target server identifier. The preset duration threshold may be set according to actual requirements, such as 5 minutes, etc.

It is worth noting that the server corresponding to the server identifier with a duration greater than the preset duration threshold can be understood as an active server in the cluster. That is, the server corresponding to the target server identifier is an active server in the cluster.

After the target server identifier is determined, the server evenly distributes the advertisement groups to be distributed to the server corresponding to the target server identifier, so that the server obtains the event message corresponding to the advertisement groups.

It should be understood that each advertisement group includes advertisements published by the same advertiser. That is, each advertisement group can carry object identifiers corresponding to advertisements published by the same advertiser. When evenly distributing the advertisement groups to be distributed, the even distribution can be performed according to the number of advertisement groups to be distributed and the number of target server identifiers. For example, when the number of advertisement groups to be distributed is 10 and the number of target server identifiers is 5, then each server corresponding to a target server identifier can be allocated 2 advertisement groups.

It should be noted that, in the embodiments of the present disclosure, the number of advertisements included in each advertisement group may not be considered. By grouping advertisements published by the same advertiser into the same advertisement group, the data of the advertisements published by the same advertiser can be managed by the same server, thereby avoiding subsequent data merging.

Therefore, through the above implementations, multiple advertisement groups can be evenly distributed to multiple active servers, thereby achieving load balancing.

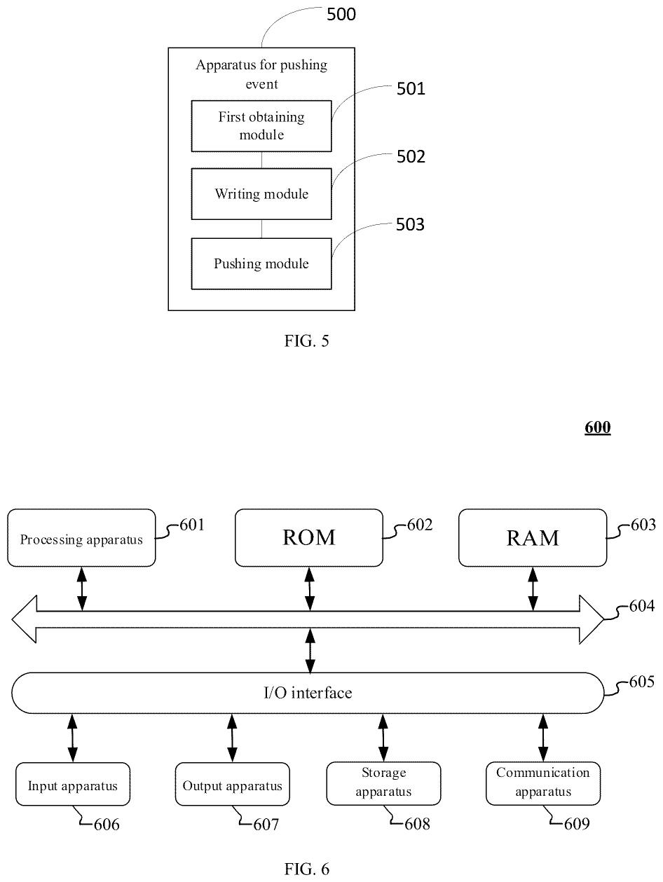

FIG. 5 is a schematic diagram of module connection in an apparatus for pushing an event according to an exemplary embodiment. As shown in FIG. 5, the embodiments of the present disclosure provide an apparatus for pushing an event 500, and the apparatus for pushing an event 500 includes: a first obtaining module 501, a writing module 502, and a pushing module 503.

The first obtaining module 501 is configured to obtain an event message, where the event message is an event representing that change occurs for data of an advertisement corresponding to the event message.

The writing module 502 is configured to write an object identifier of the event message for which first time stamp is within a preset aggregation time window into a corresponding data set according to the preset aggregation time window, where the object identifier is used for identifying the advertisement corresponding to the event message.

The pushing module 503 is configured to read the object identifier in the data set, and push the object identifier to an advertiser terminal corresponding to the object identifier, so that the advertiser terminal obtains advertisement data corresponding to the object identifier according to the object identifier.

Optionally, the data set includes a first set and a second set, the first set is used for storing an object identifier corresponding to an advertisement published by a same advertiser, and the second set is used for storing an aggregation identifier corresponding to the first set.
the writing module 502 includes: a first writing unit and a second writing unit.

The first writing unit is configured to write the object identifier of the event message for which first time stamp is within the aggregation time window into a corresponding first set according to the preset aggregation time window; and

The second writing unit is configured to write the aggregation identifier corresponding to the first set into the second set in response to an end of the aggregation time window.

Optionally, the first writing unit is specifically configured to:
write the object identifier of the event message for which first time stamp is within the aggregation
time window into the corresponding first set according to the preset aggregation time window and in combination with a preset deduplication rule.

Optionally, the pushing module 503 includes: a first reading unit, a second reading unit and a pushing unit.

The first reading unit is configured to read the aggregation identifier from the second set according to a preset time period.

The second reading unit is configured to read the object identifier from the first set corresponding to the aggregation identifier according to the aggregation identifier.

The pushing unit is configured to push the object identifier to the advertiser terminal corresponding to the read object identifier.

Optionally, the pushing unit is specifically configured to:
segment the read object identifier according to a preset segmentation size to obtain multiple data segments; and
for each of the data segments, send the data segment to the corresponding advertiser terminal through a request message.

Optionally, the apparatus 500 further includes: a first determination module and a second determination module.

The first determination module is configured to determine a random offset corresponding to the event message according to the object identifier carried in the event message.

The second determination module is configured to determine the first time stamp corresponding to the event message according to the random offset and an original time stamp of the event message.

Optionally, the apparatus 500 further includes: a second acquisition module, a third determination module, a fourth determination module and a distribution module.

The second acquisition module is configured to obtain a mapping table, where the mapping table includes a server identifier corresponding to a server and a second time stamp corresponding to the server identifier which are periodically written into the mapping table by the server in a cluster.

The third determination module is configured to determine, for each server identifier, a duration of the server identifier in the mapping table according to the second time stamp corresponding to the server identifier.

The fourth determination module is configured to determine a target server identifier according to the duration, where the target server identifier is a server identifier with a duration greater than a preset duration threshold.

The distribution module is configured to evenly distribute advertisement groups to be distributed to a server corresponding to the target server identifier, so that the server corresponding to the target server identifier obtains an event message corresponding to the advertisement groups, where the advertisement groups include advertisements published by a same advertiser.

The functional logic performed by each functional module in the above apparatus for pushing an event 500 has been described in detail in the part about the method, and will not be repeated here.

Reference is made to FIG. 6 below, which illustrates a schematic structural diagram of an electronic device (such as a terminal device or a server) 600 suitable for implementing embodiments of the present disclosure. The terminal device in the embodiments of the present disclosure can include, but is not limited to, a mobile terminal such as a mobile phone, a notebook computer, a digital broadcast receiver, a PDA (Personal Digital Assistant), a PAD (tablet computer), a PMP (Portable Multimedia Player), a vehicle-mounted terminal (for example, a vehicle-mounted navigation terminal), etc., and a fixed terminal such as a digital TV, a desktop computer, etc. The electronic device shown in FIG. 6 is only an example, and should not bring any limitations to the functions and usage scopes of the embodiments of the present disclosure.

As shown in FIG. 6, the electronic device 600 can include a processing apparatus (such as a central processing unit, a graphics processing unit, etc.) 601, which can execute various appropriate actions and processes according to a program stored in a read-only memory (ROM) 602 or a program loaded from a storage apparatus 608 into a random access memory (RAM) 603. In the RAM 603, various programs and data required for the operation of the electronic device 600 are also stored. The processing apparatus 601, the ROM 602, and the RAM 603 are connected to each other through a bus 604. An input/output (I/O) interface 605 is also connected to the bus 604.

Generally, the following apparatuses may be connected to the I/O interface 605: an input apparatus 606 including, for example, a touchscreen, a touchpad, a keyboard, a mouse, a camera, a microphone, an accelerometer, a gyroscope, etc.; an output apparatus 607 including, for example, a liquid crystal display (LCD), a speaker, a vibrator, etc.; a storage apparatus 608 including, for example, a magnetic tape, a hard disk, etc.; and a communication apparatus 609. The communication apparatus 609 may allow the electronic device 600 to perform wireless or wired communication with other devices to exchange data. Although FIG. 6 shows the electronic device 600 having various apparatuses, it should be understood that it is not required to implement or have all the illustrated apparatuses. More or fewer apparatuses may alternatively be implemented or provided.

In particular, according to the embodiments of the present disclosure, the processes described above with reference to the flowcharts can be implemented as computer software programs. For example, the embodiments of the present disclosure include a computer program product, which includes a computer program carried on a non-transitory computer-readable medium, and the computer program contains program code for executing the method shown in the flowchart. In such an embodiment, the computer program can be downloaded and installed from the network through the communication apparatus 609, or installed from the storage apparatus 608, or installed from the ROM 602. When the computer program is executed by the processing apparatus 601, the above functions defined in the method of the embodiments of the present disclosure are executed.

It should be noted that the above computer-readable medium in the present disclosure can be a computer-readable signal medium or a computer-readable storage medium, or any combination thereof. The computer-readable storage medium can be, for example, but not limited to, an electrical, magnetic, optical, electromagnetic, infrared, or semiconductor system, apparatus or device, or any combination thereof. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof. In the present disclosure, the computer-readable storage medium can be any tangible medium that contains or stores a program, and the program can be used by or in combination with an instruction execution system, apparatus, or device. In the present disclosure, the computer-readable signal medium can include a data signal propagated in a baseband or as a part of a carrier wave, in which computer-readable program code is carried. Such a propagated data signal can take many forms, including but not limited to an electromagnetic signal, an optical signal, or any suitable combination thereof. The computer-readable signal medium can also be any computer-readable medium other than the computer-readable storage medium, and the computer-readable signal medium can send, propagate, or transmit a program for use by or in combination with an instruction execution system, apparatus, or device. The program code contained on the computer-readable medium can be transmitted by any suitable medium, including but not limited to: wire, optical cable, RF (radio frequency), etc., or any suitable combination thereof.

In some implementations, the client and the server can communicate using any currently known or future-developed network protocol, such as HTTP (HyperText Transfer Protocol), and can communicate (via a communication network) and interconnect with digital data in any form or medium. Examples of the communication network include a local area network (“LAN”), a wide area network (“WAN”), the Internet, and an end-to-end network (for example, an ad hoc end-to-end network), as well as any network currently known or developed in the future.

The above computer-readable medium may be included in the above electronic device, or may exist alone without being assembled into the electronic device.

The above computer-readable medium carries one or more programs, and when the one or more programs are executed by the electronic device, the electronic device is caused to: obtain an event message, where the event message is an event representing that change occurs for data of an advertisement corresponding to the event message; write an object identifier of the event message for which first time stamp is within a preset aggregation time window into a corresponding data set according to the preset aggregation time window, where the object identifier is used for identifying the advertisement; and read the object identifier in the data set, and push the object identifier to an advertiser terminal corresponding to the object identifier, so that the advertiser terminal obtains advertisement data corresponding to the object identifier according to the object identifier.

Computer program code for performing the operations of the present disclosure can be written in one or more programming languages or a combination thereof. The above-mentioned programming languages include, but are not limited to, object-oriented programming languages such as Java, Smalltalk, C++, and also include conventional procedural programming languages such as “C” language or similar programming languages. The program code can be executed entirely on the user's computer, partly on the user's computer, as a stand-alone software package, partly on the user's computer and partly on a remote computer, or entirely on the remote computer or server. In the case of the remote computer, the remote computer can be connected to the user's computer through any kind of network, including a local area network (LAN) or a wide area network (WAN), or can be connected to an external computer (for example, via the Internet through an Internet service provider).

The flowcharts and block diagrams in the drawings illustrate the architecture, functionality, and operation of possible implementations of systems, methods, and computer program products according to various embodiments of the present disclosure. In this regard, each block in the flowcharts or block diagrams may represent a module, a program segment, or a portion of code that includes one or more executable instructions for implementing specified logical functions. It should also be noted that, in some alternative implementations, the functions noted in the blocks may occur in an order different from that noted in the drawings. For example, two blocks shown in succession can, in fact, can be executed substantially concurrently, or the two blocks can sometimes be executed in a reverse order, depending upon the functionality involved. It should also be noted that, each block of the block diagrams and/or flowcharts, and combinations of blocks in the block diagrams and/or flowcharts, can be implemented by a dedicated hardware-based system that performs the specified functions or operations, or can be implemented by a combination of dedicated hardware and computer instructions.

The modules involved in the embodiments of the present disclosure can be implemented in software or hardware. Among them, the name of the module does not constitute a limitation on the module itself under certain circumstances.

The above-mentioned functions described herein can be executed at least in part by one or more hardware logic components. For example, without limitation, exemplary types of hardware logic components that can be used include: a field programmable gate array (FPGA), an application specific integrated circuit (ASIC), an application specific standard product (ASSP), a system on chip (SOC), a complex programmable logical device (CPLD), etc.

In the context of the present disclosure, a machine-readable medium may be a tangible medium that may contain or store a program for use by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination thereof.

The above description is only preferred embodiments of the present disclosure and an explanation of the applied technical principles. Those skilled in the art should understand that the disclosure scope involved in the present disclosure is not limited to the technical solutions formed by the specific combination of the above-mentioned technical features, but also covers other technical solutions formed by the arbitrary combination of the above-mentioned technical features or their equivalent features without departing from the above-mentioned disclosed concept. For example, a technical solution formed by replacing the above-mentioned features with the technical features having similar functions disclosed in the present disclosure (but not limited to).

In addition, although the operations are described in a specific order, this should not be understood as requiring these operations to be performed in the specific order shown or in a sequential order. In some circumstances, multitasking and parallel processing may be advantageous. Similarly, although several specific implementation details are included in the above discussion, these should not be construed as limiting the scope of the present disclosure. Certain features that are described in the context of separate embodiments can also be implemented in combination in a single embodiment. Conversely, various features that are described in the context of a single embodiment can also be implemented in multiple embodiments individually or in any suitable sub-combination.

Although the subject matter has been described in language specific to structural features and/or logical actions of the method, it should be understood that the subject matter defined in the appended claims is not necessarily limited to the specific features or actions described above. Rather, the specific features and actions described above are merely exemplary forms of implementing the claims. Regarding the apparatus in the above embodiments, the specific manner in which each module performs operations has been described in detail in the embodiments related to the method, and will not be described in detail here.

1. A method for pushing an event, comprising:
obtaining an event message, wherein the event message is an event representing that change occurs for data of an advertisement corresponding to the event message;
writing an object identifier of the event message for which a first time stamp is within a preset aggregation time window into a corresponding data set according to the preset aggregation time window, wherein the object identifier is used for identifying the advertisement; and
reading the object identifier in the data set, and pushing the object identifier to an advertiser terminal corresponding to the object identifier, so that the advertiser terminal obtains advertisement data corresponding to the object identifier according to the object identifier.

2. The method according to claim 1, wherein the data set comprises a first set and a second set, the first set is used for storing an object identifier corresponding to an advertisement published by a same advertiser, and the second set is used for storing an aggregation identifier corresponding to the first set; and
the writing an object identifier of the event message for which a first time stamp is within a preset aggregation time window into a corresponding data set according to the preset aggregation time window, comprises:
writing the object identifier of the event message for which the first time stamp is within the preset aggregation time window into a corresponding first set according to the preset aggregation time window; and
in response to an end of the preset aggregation time window, writing the aggregation identifier corresponding to the first set into the second set.

3. The method according to claim 2, wherein the writing the object identifier of the event message for which the first time stamp is within the preset aggregation time window into a corresponding first set according to the preset aggregation time window comprises:
writing the object identifier of the event message for which the first time stamp is within the preset aggregation time window into the corresponding first set according to the preset aggregation time window and in combination with a preset deduplication rule.

4. The method according to claim 2, wherein the reading the object identifier in the data set and pushing the object identifier to an advertiser terminal corresponding to the object identifier comprises:
reading the aggregation identifier from the second set according to a preset time period;
reading the object identifier from the first set corresponding to the aggregation identifier according to the aggregation identifier; and
pushing the object identifier to the advertiser terminal corresponding to the read object identifier.

5. The method according to claim 4, wherein the pushing the object identifier to the advertiser terminal corresponding to the read object identifier comprises:
segmenting the read object identifier according to a preset segmentation size to obtain multiple data segments; and
for each of the data segments, sending the data segment to a corresponding advertiser terminal through a request message.

6. The method according to claim 1, wherein the first time stamp is obtained by:
determining a random offset corresponding to the event message according to an object identifier carried in the event message; and
determining a first time stamp corresponding to the event message according to the random offset and an original time stamp of the event message.

7. The method according to claim 1, further comprising:
obtaining a mapping table, wherein the mapping table comprises a server identifier corresponding to a server and a second time stamp corresponding to the server identifier which are periodically written into the mapping table by the server in a cluster;
determining, for each server identifier, a duration of the server identifier in the mapping table according to the second time stamp corresponding to the server identifier;
determining a target server identifier according to the duration, wherein the target server identifier is a server identifier with a duration greater than a preset duration threshold; and
evenly distributing advertisement groups to be distributed to a server corresponding to the target server identifier, so that the server corresponding to the target server identifier obtains an event message corresponding to the advertisement groups, wherein the advertisement groups comprise advertisements published by a same advertiser.

8. A non-transitory computer-readable medium, having a computer program stored thereon, wherein when the computer program is executed by a processing apparatus, a method for pushing an event is implemented, and the method comprises:
obtaining an event message, wherein the event message is an event representing that change occurs for data of an advertisement corresponding to the event message;
writing an object identifier of the event message for which a first time stamp is within a preset aggregation time window into a corresponding data set according to the preset aggregation time window, wherein the object identifier is used for identifying the advertisement; and
reading the object identifier in the data set, and pushing the object identifier to an advertiser terminal corresponding to the object identifier, so that the advertiser terminal obtains advertisement data corresponding to the object identifier according to the object identifier.

9. An electronic device, comprising:
a storage apparatus, having a computer program stored thereon; and
a processing apparatus, configured to execute the computer program in the storage apparatus, to implement a method for pushing an event, and the method comprises:
obtaining an event message, wherein the event message is an event representing that change occurs for data of an advertisement corresponding to the event message;
writing an object identifier of the event message for which a first time stamp is within a preset aggregation time window into a corresponding data set according to the preset aggregation time window, wherein the object identifier is used for identifying the advertisement; and
reading the object identifier in the data set, and pushing the object identifier to an advertiser terminal corresponding to the object identifier, so that the advertiser terminal obtains advertisement data corresponding to the object identifier according to the object identifier.

10. The electronic device according to claim 9, wherein the data set comprises a first set and a second set, the first set is used for storing an object identifier corresponding to an advertisement published by a same advertiser, and the second set is used for storing an aggregation identifier corresponding to the first set; and
the writing an object identifier of the event message for which a first time stamp is within a preset aggregation time window into a corresponding data set according to the preset aggregation time window, comprises:
writing the object identifier of the event message for which the first time stamp is within the preset aggregation time window into a corresponding first set according to the preset aggregation time window; and
in response to an end of the preset aggregation time window, writing the aggregation identifier corresponding to the first set into the second set.

11. The electronic device according to claim 10, wherein the writing the object identifier of the event message for which the first time stamp is within the preset aggregation time window into a corresponding first set according to the preset aggregation time window comprises:
writing the object identifier of the event message for which the first time stamp is within the preset aggregation time window into the corresponding first set according to the preset aggregation time window and in combination with a preset deduplication rule.

12. The electronic device according to claim 10, wherein the reading the object identifier in the data set and pushing the object identifier to an advertiser terminal corresponding to the object identifier comprises:
reading the aggregation identifier from the second set according to a preset time period;
reading the object identifier from the first set corresponding to the aggregation identifier according to the aggregation identifier; and
pushing the object identifier to the advertiser terminal corresponding to the read object identifier.

13. The electronic device according to claim 12, wherein the pushing the object identifier to the advertiser terminal corresponding to the read object identifier comprises:
segmenting the read object identifier according to a preset segmentation size to obtain multiple data segments; and
for each of the data segments, sending the data segment to a corresponding advertiser terminal through a request message.

14. The electronic device according to claim 9, wherein the first time stamp is obtained by:
determining a random offset corresponding to the event message according to an object identifier carried in the event message; and
determining a first time stamp corresponding to the event message according to the random offset and an original time stamp of the event message.

15. The electronic device according to claim 9, further comprising:
obtaining a mapping table, wherein the mapping table comprises a server identifier corresponding to a server and a second time stamp corresponding to the server identifier which are periodically written into the mapping table by the server in a cluster;
determining, for each server identifier, a duration of the server identifier in the mapping table according to the second time stamp corresponding to the server identifier;
determining a target server identifier according to the duration, wherein the target server identifier is a server identifier with a duration greater than a preset duration threshold; and
evenly distributing advertisement groups to be distributed to a server corresponding to the target server identifier, so that the server corresponding to the target server identifier obtains an event message corresponding to the advertisement groups, wherein the advertisement groups comprise advertisements published by a same advertiser.

16. The non-transitory computer-readable medium according to claim 8, wherein the data set comprises a first set and a second set, the first set is used for storing an object identifier corresponding to an advertisement published by a same advertiser, and the second set is used for storing an aggregation identifier corresponding to the first set; and
the writing an object identifier of the event message for which a first time stamp is within a preset aggregation time window into a corresponding data set according to the preset aggregation time window, comprises:
writing the object identifier of the event message for which the first time stamp is within the preset aggregation time window into a corresponding first set according to the preset aggregation time window; and
in response to an end of the preset aggregation time window, writing the aggregation identifier corresponding to the first set into the second set.

17. The non-transitory computer-readable medium according to claim 16, wherein the writing the object identifier of the event message for which the first time stamp is within the preset aggregation time window into a corresponding first set according to the preset aggregation time window comprises:
writing the object identifier of the event message for which the first time stamp is within the preset aggregation time window into the corresponding first set according to the preset aggregation time window and in combination with a preset deduplication rule.

18. The non-transitory computer-readable medium according to claim 16, wherein the reading the object identifier in the data set and pushing the object identifier to an advertiser terminal corresponding to the object identifier comprises:
reading the aggregation identifier from the second set according to a preset time period;
reading the object identifier from the first set corresponding to the aggregation identifier according to the aggregation identifier; and
pushing the object identifier to the advertiser terminal corresponding to the read object identifier.

19. The non-transitory computer-readable medium according to claim 18, wherein the pushing the object identifier to the advertiser terminal corresponding to the read object identifier comprises:
segmenting the read object identifier according to a preset segmentation size to obtain multiple data segments; and
for each of the data segments, sending the data segment to a corresponding advertiser terminal through a request message.

20. The non-transitory computer-readable medium according to claim 8, wherein the first time stamp is obtained by:
determining a random offset corresponding to the event message according to an object identifier carried in the event message; and
determining a first time stamp corresponding to the event message according to the random offset and an original time stamp of the event message.
